(19) United States
(12) Patent Application Publication
(10) Pub. No.: US 2010/0175718 A1
(43) Pub. Date: Jul. 15, 2010

(54) APPARATUS AND ASSOCIATED METHOD FOR CONTROLLING A WASHING FLUID LEVEL IN A DISHWASHER

(75) Inventors: Fred Dennis Kedjierski, Kinston, NC (US); Dennis A. Poyner, Kinston, NC (US); Mark D. Montgomery, Greenville, NC (US); Troy Dalsing, Kinston, NC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Electrolux Home Products, Inc.

(21) Appl. No.: 12/351,325

(22) Filed: Jan. 9, 2009

(51) Int. Cl. B08B 3/04

(52) U.S. Cl. 134/18; 134/56 D

(57) ABSTRACT

A method and associated device and appliance for controlling a washing fluid level in a dishwashing appliance are provided. A sump assembly of a dishwashing appliance is filled with washing fluid to a predetermined fluid level determined by a fluid level sensing device directly engaged with the sump assembly. The sump assembly is operably engaged with a tub portion at a lower end thereof. Washing fluid is circulated between the sump assembly and the tub portion. After circulating the washing fluid, an operational fluid level within the sump assembly is determined by the fluid level sensing device. When the operational fluid level differs from the predetermined fluid level by more than a threshold level, one of a washing fluid drain valve and a washing fluid fill valve is actuated to substantially restore the washing fluid to the predetermined fluid level.

### BACKGROUND OF THE INVENTION

1. Field of the Invention

Embodiments of the present invention relate to dishwashing appliances and, more particularly, to an apparatus and associated method for controlling a washing fluid level in a dishwashing appliance.

2. Description of Related Art

The effectiveness of a dishwasher may often be directly related to conditions associated with the water used thereby for cleaning dishware and other items. For example, the dishwasher's cleaning capability and/or efficiency may be related to the amount of water used by the dishwasher (i.e., the water level in the dishwasher associated with a “full” level). Further, the amount of water circulated through the dishwasher during the wash cycle may directly affect the electrical energy used by the dishwasher. Of course, water conservation is often as issue associated with appliances such as dishwashers. Thus, there is a continuing demand for increased energy efficiency, often reflected in industry certifications. In addition, consumer demand may include more complex wash routines, often involving partial water pump outs and partial re-fills of the dishwasher tub. In some instances, improved safety, efficiency, and/or control of the dishwasher may also be desirable. In other instances, it may also be beneficial to be able to determine circulation water lost to dishware oriented in an “open side up” orientation, wherein the dishware (e.g., a cup or bowl) may retain the water therein due to its orientation, and remove that water from circulation through the dishwasher (i.e., a loss of fluid/water used for cleaning the dishware).

In certain instances, any or all of these factors may be affected by precise control of the water level within the dishwasher. Current provisions for determining/controlling the water level in a dishwasher include, for example, float mechanisms, pressure switches/pressure transducers (i.e., capable of sensing and controlling a water level over a given continuous range corresponding to the range of the switch/transducer), and/or timed valve operations to fill/drain based on expected water inlet and discharge parameters. Though it may increase costs and require more space, multiple water levels can be sensed and controlled through the use of multiple devices. However, such provisions may be generally limited in their use.

More particularly, in this regard, the use of timed valves to control the water level within a dishwasher may be generally considered a low-cost solution, but may have potential disadvantages. For example, timed valves may lead to inaccuracy because the water level within the dishwasher may not be known with certainty. That is, achieving the correct water level may be based on an assumption about the starting condition, often that the unit is initially empty or that it contains a particular small volume of water. Further, the orientation and/or anti-backflow provision of the drain hose/drain assembly may affect how much water drains back into the sump of the dishwasher, once the drain function of the dishwasher is completed. Such factors may, in some instances, result in overfilling of the dishwasher. Further, timed valves may also lead to inaccuracy in the fill level because the rate of water coming in or out of the dishwasher is assumed to fall within a given range with respect to, for example, the water flow rate typically available from a house source. However, changes in water supply pressure, or drain pipe routing (e.g., due to length, elevation change, type of vent or kinking), may have a significant adverse impact on the actual water volume that is directed into the dishwasher, and the resulting water level therein, during the timed operation of the valves. In addition, timed valves may result in a higher risk of the dishwasher not running at optimal efficiency (i.e., with not enough water, or with too much water) since the water level is not actually sensed. That is, there is no actual knowledge or confirmation that water actually entered or left the unit—only that the valve was energized. Also, timed valves may be considered inefficient with respect to energy usage because this methodology may result in more or less water being used during a dishwashing cycle than is actually necessary or required. In order to prevent an underfill condition, the open time for the fill valve may need to be set to accommodate the lowest possible water supply condition. However, such a setting may carry an associated risk of overfilling should the house supply conditions be greater than the pre-selected minimum. Finally, timed valves are unable to detect circulated water lost to dishware oriented in an “open side up” position (i.e., water captured and removed from circulation by upright dishware or other glassware).

Float mechanisms used for determining/controlling the water level in some dishwashers may also have associated disadvantages. For example, such float mechanisms may be generally unreliable because of the mechanical linkage to the switch/actuator controlling the valve(s) (i.e., effects on operation through friction, wear, binding, and/or blockage by food soils). In addition, the mechanical linkage may, in some instances, penetrate the wall of the tub or sump of the dishwasher, thus resulting in a potential leak path of the water within the dishwasher, which may adversely affect the water valve switch/actuator associated therewith. Further, such float mechanisms may undesirably require significant space to provide/maintain operating clearance for float movement (i.e., the float element may need to be relatively large to achieve the necessary buoyancy). Also, the underside of the float element, particularly a float element configured to define a concave lower surface which acts as an air trap, provides a hard-to-clean surface where bacteria can grow.

Pressure switches/transducers capable of sensing and controlling a water level over a given continuous pressure range, may have a small pressure-sensing tube that transfers the water pressure to a mechanism (i.e., bellows) inside the switch/transducer housing. The pressure-sensing tube may also have the potential of being blocked by food soils, and/or by buildup from water hardness or other contaminants, and may become pinched or kinked if not appropriately configured. Also, in some instances, pressure switches/transducers may be relatively expensive, and thus generally undesirable for use in mass-produced dishwashers.

Thus, there exists a need for a method and apparatus for a dishwashing appliance for more precisely controlling the water level within a dishwasher, upon the dishwasher being filled and/or during a water circulation procedure, so as to maintain an optimum water level within the dishwasher for a particular selected dishwashing process.

### BRIEF SUMMARY OF THE INVENTION

The above and other needs are met by the present invention which, according to one aspect, provides a method of controlling a washing fluid level in a dishwashing appliance. Such a method comprises filling a sump assembly of a dishwashing appliance with washing fluid to a predetermined fluid level, wherein the predetermined fluid level is determined by a fluid level sensing device directly engaged with a sump assembly. The sump assembly is operably engaged with a tub portion at a lower end thereof. A washing fluid is circulated between the sump assembly and the tub portion. After circulating washing fluid, an operational fluid level within the sump assembly is determined by the fluid level sensing device. When the operational fluid level differs from the predetermined fluid level by more than a threshold level, one of a washing fluid drain valve and a washing fluid fill valve is actuated to substantially restore the washing fluid to the predetermined fluid level.

Another aspect provides a fluid level control device for a dishwashing appliance having a tub portion adapted to contain washing fluid for circulation about dishware received therein, wherein the dishwashing appliance further includes a sump assembly disposed at a lower end of the tub portion for receiving the washing fluid therefrom, a washing fluid drain valve for removing washing fluid from the dishwashing appliance, and a washing fluid fill valve for directing washing fluid to the dishwashing appliance. Such a fluid level control device comprises a fluid level sensing device adapted to be directly engaged with the sump assembly of the dishwashing appliance, wherein the fluid level sensing device is configured to determine a washing fluid level, including a predetermined fluid level and an operational fluid level, associated with the washing fluid within the dishwashing appliance, and to generate a first signal and a second signal corresponding to the predetermined fluid level and the operational fluid level, respectively. A controller device is in communication with the fluid level sensing device and is configured to receive the first signal therefrom and respond to the first signal to originate a washing fluid circulation event such that washing fluid is circulated between the sump assembly and the tub portion. The controller device being further configured to receive the second signal after at least a portion of the washing fluid circulation event has elapsed, and respond to the second signal to direct actuation of one of the washing fluid drain valve and the washing fluid fill valve when the operational fluid level differs from the predetermined fluid level by more than a threshold level, to substantially restore the washing fluid to the predetermined fluid level.

Yet another aspect provides a dishwashing appliance, comprising a tub portion configured to contain washing fluid for circulation about dishware received therein, and a sump assembly disposed at a lower end of the tub portion for receiving the washing fluid therefrom. A washing fluid drain valve is in communication with the sump assembly for removing washing fluid therefrom, and a washing fluid fill valve is in communication with the sump assembly for directing washing fluid thereto. A fluid level sensing device is directly engaged with the sump assembly of the dishwashing appliance, wherein the fluid level sensing device is configured to determine a washing fluid level, including a predetermined fluid level and an operational fluid level, associated with the washing fluid within the dishwashing appliance, and to generate a first signal and a second signal corresponding to the predetermined fluid level and the operational fluid level, respectively. A controller device is in communication with the fluid level sensing device and is configured to receive the first signal therefrom and respond to the first signal to originate a washing fluid circulation event such that washing fluid is circulated between the sump assembly and the tub portion. The controller device being further configured to receive the second signal after at least a portion of the washing fluid circulation event has elapsed, and respond to the second signal to direct actuation of one of the washing fluid drain valve and the washing fluid fill valve when the operational fluid level differs from the predetermined fluid level by more than a threshold level, to substantially restore the washing fluid to the predetermined fluid level.

Aspects of the present invention may thus provide significant advantages as further detailed herein.

### BRIEF DESCRIPTION OF THE SEVERAL VIEWS OF THE DRAWINGS

Having thus described various embodiments of the invention in general terms, reference will now be made to the accompanying drawings, which are not necessarily drawn to scale, and wherein:

FIG. 1 is a perspective view of a dishwasher capable of implementing various embodiments of the present disclosure;

FIG. 2 is a perspective view of a sump assembly capable of implementing various embodiments of the present disclosure;

FIG. 3A is a fragmentary schematic side view of a dishwasher implementing a fluid level sensing device including an optical sensor device, according to one embodiment of the present disclosure;

FIG. 3B is a plan view of a reflective portion associated with the fluid level sensing device shown in FIG. 3A, according to one embodiment of the present disclosure;

FIG. 4A is an electrical schematic of a fluid level sensing device capable of being implemented in a dishwasher, wherein the fluid level sensing device includes a resistive sensor device, according to one embodiment of the present disclosure;

FIG. 4B is a plan view of a fluid level sensing device including a resistive sensor device, according to one embodiment of the present disclosure;

FIG. 4C is an elevation of the fluid level sensing device shown in FIG. 4B, according to one embodiment of the present disclosure;

FIG. 5A is an elevation of a fluid level sensing device implemented in a dishwasher, wherein the fluid level sensing device includes a magnetic sensor device, according to one embodiment of the present disclosure;

FIG. 5B is an elevation of a fluid level sensing device including a magnetic sensor device implemented in a dishwasher, according to an alternate embodiment of the present disclosure;

FIG. 6A is an elevation of a fluid level sensing device including a conductive sensor device associated with a sump assembly of a dishwasher, according to one embodiment of the present disclosure; and

FIG. 6B is an elevation of a fluid level sensing device including a conductive sensor device implemented in a dishwasher, wherein the conductive sensor device is mounted with respect to a wall of a sump assembly, according to one embodiment of the present disclosure.

### DETAILED DESCRIPTION OF VARIOUS EMBODIMENTS OF THE INVENTION

Various embodiments of present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

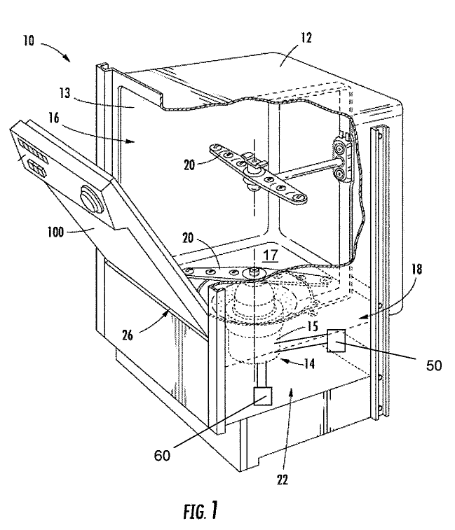

FIG. 1 illustrates one example of a dishwasher 10 capable of implementing various embodiments of the present invention. Such a dishwasher 10 typically includes a tub portion 12 (partly broken away in FIG. 1 to show internal details, and also referred to herein as “tub” or “tub 12”) having a plurality of walls (e.g., side wall 13) for forming an enclosure in which dishes, utensils, and other dishware may be placed for washing. The tub portion 12 may also define a forward access opening, generally designated as 16. As known in the art, the dishwasher 10 may also include slidable bottom and upper racks (not shown) for holding the dishes, utensils, and dishware. A door assembly 100 may be pivotably engaged with the tub portion 12 about the lower end 18 thereof so as to selectively permit access to the interior of the tub portion 12. That is, a lower edge 26 of the door assembly 100 may be pivotably engaged (i.e., hinged) with the lower end 18 of the tub portion 12 such that the door assembly 100 is pivotable about the lower edge 26 thereof to provide access to the interior of the tub portion 12 through the forward access opening 16, and to cover and seal the forward access opening 16 when the dishwasher 10 is in operation.

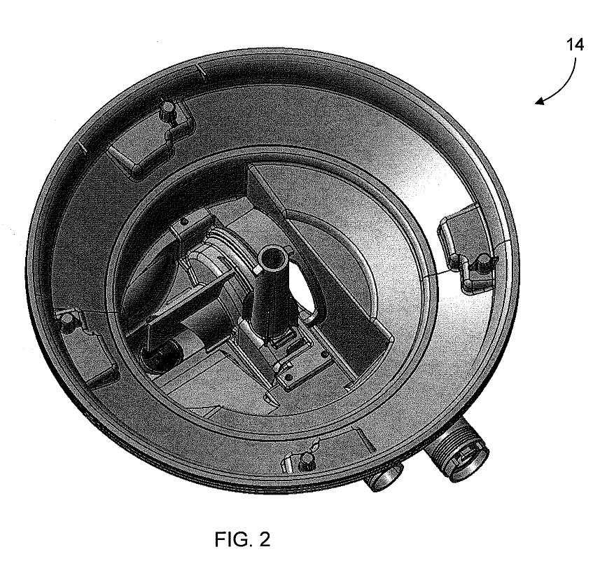

The tub portion 12 may define a sump assembly, generally designated as 14, in which wash water or rinse water is collected, typically under the influence of gravity, wherein the sump assembly 14 may cooperate with a bottom wall 17 to enclose the dishwasher about the lower end 18 of the tub portion 12. The wash/rinse water may be pumped by a pump 15 out of the sump assembly 14 to various spray arms 20 mounted in the interior of the tub portion 12 for spraying the wash/rinse water, under pressure, onto the dishes, utensils, and other dishware contained therein. The dishwashing fluid collected in the sump assembly 14 is re-circulated through the spray arm(s) 20 during each of the wash and rinse cycles typically implemented by the dishwasher 10. As illustrated in FIG. 2, the sump assembly 14 may be integrally-formed and configured to receive washing fluid therein. The sump assembly 14 may include/define various inlet ports and outlet ports in communication with various operational components of the dishwasher 10. For example, a washing fluid fill valve (“fill valve”) 50 and a washing fluid drain valve (“drain valve”) 60 may each be in communication with the sump assembly 14 or otherwise with the dishwasher 10. The fill valve 50 is configured to be actuatable to direct washing fluid from a house supply/source to the sump assembly 14 or otherwise to the tub portion 12 of the dishwasher 10. The drain valve 60 may be fluidly disposed between a drain pump and a house drain, wherein the drain valve may be actuatable to allow the washing fluid to be directed from the sump assembly 14/tub portion 12 to the house drain. Through selective actuation of the fill valve 50/drain valve 60, washing fluid may be selectively added or removed from the dishwasher 10. The drain valve 60 and the fill valve 50 may be configured to be electrically actuated (i.e., electrically opened and closed), though one skilled in the art will appreciate that such valves may be actuated in different ways such as, for example, mechanically, hydraulically, and/or in other appropriate manners.

With reference to FIG. 1, particular operational components (e.g., circulation pump, drain pump, fill valve, drain valve) may be housed, disposed, or otherwise positioned within a base portion/component 22 positioned beneath the tub portion 12, wherein the base portion 22 is configured to receive and support the lower end 18 of the tub portion 12. In some instances, the base portion 22 may be a separate component with respect to the tub portion 12, such as, for example, a molded polymer component, while in other instances the base portion 22 may be integral with the tub portion 12 such that the side walls forming the tub portion 12 also at least partially form the base portion 22.

The dishwasher 10 may typically include a number of selectable wash programs each having a particular combination of various parameters of the dishwashing process. Such wash programs may be selectable by the user on a display screen, touch pad, or other control panel or control device generally associated with the pivotable door 100 connected to the dishwasher 10. The control panel may include or be in communication with a control circuit configured to vary the parameters of the appropriate components consistently with the wash program selected by the user. That is, the user selects the wash program by, for example, pressing a button or actuating an input device associated with the desired wash program on the control panel/control device such that a signal associated with that wash program is directed to the control circuit for processing by, for instance, a processor or other computer device operable therewith to direct the parameters used by the various dishwasher appliance components to effectuate the selected wash program. Accordingly, the parameters, including, for example, particular durations for each cycle segment/event (e.g., a fill event, a circulation event) of the wash program, the temperature of the water used by such segments/events, and the amount of water used during such segments/events, may be adjusted and controlled by the control circuit, the processor, or other associated control device, as will be appreciated by one skilled in the art.

In some aspects, the dishwasher 10 may include provisions for determining/controlling the washing fluid level therein during the various segments/events associated with a selected wash program. According to various aspects of the invention, such determination/control of the washing fluid level may be accomplished in any suitable manner, to address particular shortcomings associated with some prior art washing fluid level determination/control provisions so as to account for, for example, inverted dishware, timing valve issues, food soils carried in the water, etc. In this regard, embodiments of the present invention may be implemented in a dishwasher to more precisely control the water level within the dishwasher, upon the dishwasher being filled, and at least during a water circulation procedure, so as to maintain an optimum water level within the dishwasher for a particular dishwashing process, and to increase the efficiency of the dishwasher due to the maintenance of that optimum water level.

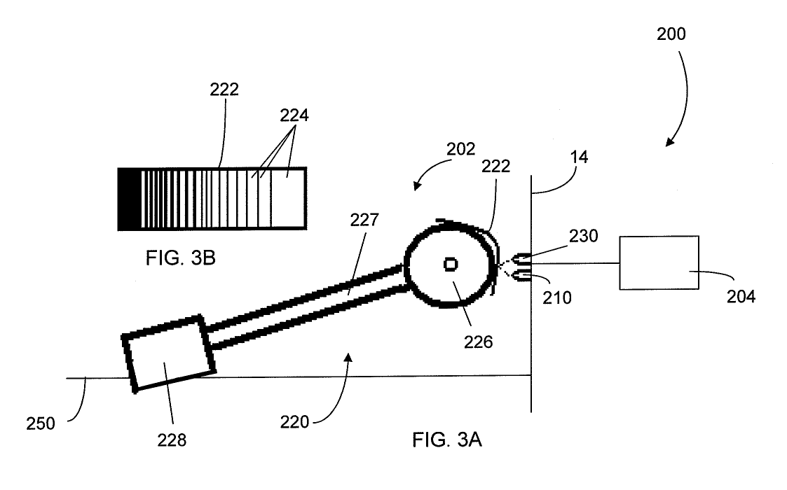

In accordance with such embodiments of the present disclosure, with reference to FIGS. 3-6, the dishwasher 10 may include a fluid level control device 200 for determining/controlling a washing fluid level within the dishwasher 10 so as to improve the efficiency thereof. Such determination/control of the washing fluid level may be accomplished through direct, real-time interaction with the washing fluid, as the washing fluid level changes. As used herein, the term “washing fluid” generally refers to any fluid used in the dishwashing process, wherein the washing fluid may be rinse water used to rinse the dishware, wash fluid having chemicals or additives being carried by water, or any other fluid types used in the dishwashing process as known by those of skill in the art. The fluid level control device 200 may comprise, for example, a fluid level sensing device 202 configured to determine a washing fluid level, or status of the washing fluid (i.e., whether the level is falling, rising, or constant), within the sump assembly 14/tub portion 12. In some instances, the fluid level sensing device 202 may be disposed within or otherwise operably engaged with the sump assembly 14 so as to be capable of interacting with the washing fluid therein. The fluid level sensing device 202 may be further configured to generate one or more signals associated with the washing fluid level, and/or status thereof, sensed thereby. In one instance, the fluid level sensing device 202 is configured to generate a first signal associated with a predetermined/preselected washing fluid level (measured within the sump assembly 14 or with respect to the sump assembly 14), when that washing fluid level in the tub portion 12/sump assembly 14 is attained. Further, the fluid level sensing device 202 may be configured to generate a second signal associated with an operational fluid level (i.e., a post-circulation fluid level), at some point after circulation of the washing fluid within the tub portion 12/sump assembly 14. That is, the washing fluid circulation event may be paused, interrupted, or otherwise stopped such that the operational fluid level may be determined by the fluid level sensing device 202. Thereafter, the washing fluid circulation event may be continued without addition or removal of washing fluid or washing fluid may be added or removed accordingly.

The fluid level control device 200 may further comprise a controller device 204 in communication with the fluid level sensing device 202, wherein, in some instances, the controller device 204 may be an electronic controller device. The controller device 204 may be configured to receive the first signal associated with the determined washing fluid level and/or status from the fluid level sensing device 202. The controller device 204 may be further configured to communicate with the drain valve 60 and/or the fill valve 50 of the dishwasher 10, and to direct operation of the drain valve 60 and/or the fill valve 50 in response to the second signal received from the fluid level sensing device 202. More particularly, the fluid level control device 200 (implementing, in some instances, an appropriate control scheme or process), may be capable of more particularly determining the washing fluid level within the dishwasher 10, upon the tub portion 12/sump assembly 14 originally being filled, and/or during a washing fluid circulation event associated with a portion of a wash cycle, such that the controller device 204 both knows (i.e., tracks the washing fluid level in real time) and maintains the optimum water level (i.e., a predetermined or preselected washing fluid level for a particular portion of a wash cycle) within the tub portion 12/sump assembly 14 for a particular wash program and/or wash cycle segment/event.

By more precisely controlling the washing fluid level in the tub portion 12/sump assembly 14, desirable effects may be realized such as, for example, lower energy and resource use, maintaining of adequate washing fluid levels, increased system stability, improved dilution and discharge of soils, and/or lower sound levels. The “optimal” washing fluid level is not necessarily a single washing fluid level, but may vary based on several factors, including, for instance, the particular wash cycle segment/event (wash, rinse, drain, etc.), the amount and/or type of soils within the tub portion 12/sump assembly 14, the overall soil loading, dishware orientation, circulation/drain pump speed, and dishwasher design (filter system, sump geometry, etc.). In some instances, details of the particular configuration of the dishwasher 10 may be directed to the controller device 204, along with the signal(s) from the fluid level sensing device 202, from which the controller device 204 can determine a real-time or substantially real time washing fluid level within the tub portion 12/sump assembly 14.

In one embodiment, the fluid level sensing device 202 may be configured to measure an amount of the washing fluid available for circulation during a portion of a wash program run by the dishwasher 10. For example, the fluid level control device 200 may be configured to determine when the washing fluid has reached a predetermined/preselected level during a filling segment/event/procedure which may involve, for example, appropriate control of the fill valve 50 and/or drain valve 60. Once the fluid level control device 200 determines that the predetermined/preselected washing fluid level has been attained in the filling segment, that fluid level control device 200 may then initiate at least a portion of a circulation event in the dishwasher 10 such that the washing fluid is at least partially circulated over the dishware disposed therein. After the washing fluid has been circulated over the dishware within the dishwasher 10, the fluid level control device 200 may be further configured to check the washing fluid level within the dishwasher 10. If a deficiency or other discrepancy (e.g., exceeding a threshold level or range) is determined by the fluid level control device 200 to exist between the predetermined/preselected washing fluid level and the post-circulation washing fluid level (i.e., the operational fluid level), the fluid level control device 200 may be further configured to remedy the deficiency/discrepancy by, for example, directing actuation of the fill valve 50 in order to replace washing fluid that may have been removed from the tub portion 12/sump assembly 14 during the circulation process, for example, by being captured by dishware oriented in an “open end up” manner. As such, embodiments of the present invention may be directed toward the replacement of any deficient amount of washing fluid lost (i.e., removed from circulation) in a circulation process in a more precisely controlled manner (i.e., only the required amount of washing fluid is added to replace the deficiency). Similarly, if an overfill condition is detected, the fluid level control device 200 may be configured to remedy the deficiency/discrepancy by directing actuation of the drain valve 60 in order to remove excess washing fluid from the tub portion 12/sump assembly 14. In still other instances, the fluid level control device 200 may be configured to direct actuation of combinations of the fill valve 50 and the drain valve 60, so as to attain the desired washing fluid fill level.

Many different types of fluid level sensing devices 202 may be implemented in the aspects disclosed herein to sense or otherwise determine the washing fluid level in the dishwasher 10 such as, for example, optical sensors, resistive sensors, magnetic sensors, and conductive sensors. In some instances, the “full” washing fluid level is toward the lower end 18/sump assembly 14 of the dishwasher 10. As such, aspects of the fluid level sensing device 202 may be disposed at a relatively low level in the dishwasher 10 (i.e., within the lower end 18 of the tub portion 12 or within the sump assembly 14) so as to generally correspond to the “full” washing fluid level. In some instances, the fluid level sensing device 202 may be configured to extend below the “full” washing fluid level and to determine/confirm that washing fluid is entering or being removed from the dishwasher 10, during appropriate fill/drain events. In this manner, the monitoring of the actual washing fluid level within the dishwasher 10 may prevent a wash program/segment/event from proceeding without adequate amounts of washing fluid within the unit which, if not remedied, may damage dishwasher components such as the circulation pump.

Aspects of the fluid level control device 200 may also be implemented to determine the time required to drain a known volume of washing fluid from the dishwasher 10. By determining this information (i.e., drainage rate), the fluid level control device 200 can also be used to actuate the drain valve 60 to an open position for a particular duration to draw down the washing fluid to the desired level in the dishwasher 10. By addressing both fill conditions and drain conditions, aspects of the present invention may also be capable of detecting and controlling, via the fill and drain valves 50, 60, the washing fluid level over a large range of flow conditions associated with both the incoming and outgoing washing fluid flows. In this manner, aspects of the dishwasher 10 may not be substantially affected by fluctuations in the pressure or other conditions of the house washing fluid supply, or by unfavorable (i.e., restricted) drain configurations. Further, the fluid level sensing device 202 may also be capable of detecting the amount of washing fluid captured or removed from circulation by various dishware (e.g., cups and bowls) within the dishwasher 10, and readjusting the washing fluid level within the dishwasher 10 to the minimum level required for an acceptable wash. The sensor circuitry associated with the fluid level control device 200 may, in some instances, be configured to include, for example, turbidity and/or temperature sensing circuits. In addition, the fluid level sensing device 202 may also have the advantage of having no moving parts, and may be configured to have smooth surfaces that may be easily cleaned.

In one embodiment, as illustrated in FIG. 3A, the fluid level sensing device 202 may comprise an optical sensor device having a light-sensitive detector 210 operably engaged with and capable of sensing light emitted from an associated light source 230. In one instance, the light-sensitive detector 210 and the light source 230 may be relatively disposed such that the washing fluid is disposed at least partially therebetween at or about the “full” washing fluid level, whereby a change in the sensed light by the light-sensitive detector 210 in response to the washing fluid is associated with the detected fluid level at a particular time. In some aspects, the optical sensor device may be configured to be operable with infrared light wherein, for example, infrared light emitted by the light source 230 is capable of being detected by the light-sensitive detector 210. Accordingly, each of the light source 230 and associated light-sensitive detector 210 may be suitably mounted in a mutually opposing relation with respect to the sump assembly 14/tub portion 12.

However, one skilled in the art will appreciate that the light source 230 and associated light-sensitive detector 210 may be configured in many different manners so as to be operable according to aspects disclosed herein. For example, an arm member 227 may be pivotably engaged with the sump assembly 14 at one end thereof about an engagement area 226. The arm member 227 may further include a float member 228 engaged therewith about an opposing end. The float (buoyant) member 228 is thus configured to move in an arcuate motion about the engagement area 226, in conjunction with the washing fluid level 250, as the washing fluid level 250 increases/decreases. The arm member 227 may, in some instances, have a plurality of uniquely-configured reflective portions 222 engaged therewith (see, e.g., FIG. 3B), wherein each reflective portion 222 includes, for example, a different amount of exposed reflective area 224. In this manner, the light source 230 and the light-sensitive detector 210, may both be directed toward the reflective portions 222 engaged with the arm member 227. As such, as the arm member 227 rotates about the engagement area 226, the reflective portions 222 move with respect to one of the light-sensitive detector 210 and the light source 230 (i.e., a light emitting diode (LED) or other suitable light source). Thus, the amount of light (at least a portion of the light emitted from the light source 230), reflected from the exposed reflective area 224 of the reflective portion 222 interacting with the emitted light (as the arm member 227 pivots in conjunction with the float member 228, from the float member 227 responding to the water level 250), and detected by the light-sensitive detector 210, may provide a substantially continuous measure of the washing fluid level 250. In some instances, the substantially continuous measure of the washing fluid level may be provided substantially in real time.

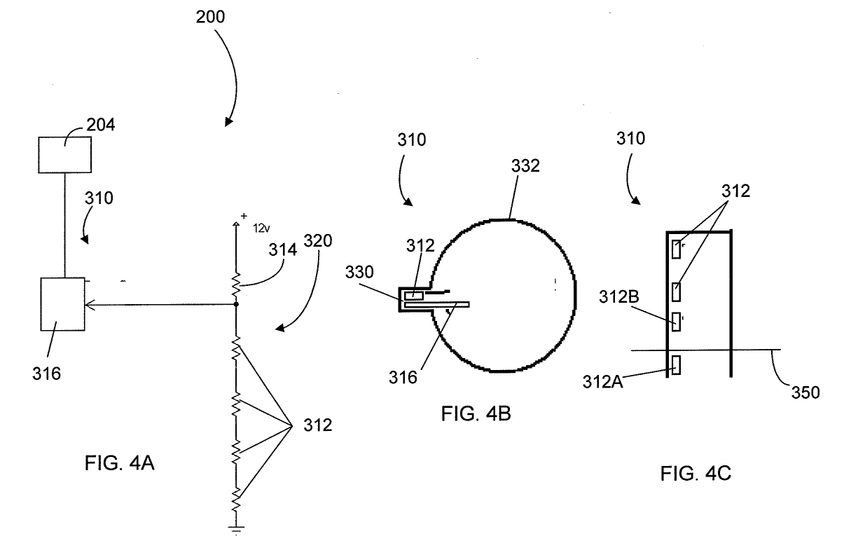

In another embodiment, as illustrated in FIGS. 4A-4C, the fluid level sensing device 202 may comprise a resistive sensor device 310 configured to detect changes in voltage and/or resistance that may be associated with the washing fluid level and/or a change in the washing fluid level. More particularly, aspects of such a resistive sensor device 310 may include a plurality of resistor members 312 (i.e., Negative Temperature Coefficient (NTC) resistors) implemented in a voltage divider 320, along with a fixed resistor 314, as schematically illustrated in FIG. 4A. In some instances, the resistive sensor device 310 may be disposed about one of the “full” washing fluid levels (each wash cycle or program may have various “full” washing fluid levels associated therewith for performing various operations) to interact with the washing fluid, whereby a change in the sensed voltage/resistance by the resistive sensor device 310 in response to the washing fluid is associated with the detected fluid level at a particular time. In this regard, the resistive sensor device 310 may be configured to be in communication with a monitoring device 316 (i.e., a microprocessor or processing device implemented in conjunction with a printed circuit board) configured to monitor at least one of a voltage change and a resistance change associated with the voltage divider 320 in response to the interaction thereof with the washing fluid associated with the washing fluid level. More particularly, electrical current passing through the resistors 312 generally causes the resistors 312 to heat up. In some instances, the resistors 312 may be disposed in series along the washing fluid fill direction, in a fold 330 of a sensor housing 332, and may be coated, for example, in thermal grease for good heat conduction. As the washing fluid level 350 rises to interact with a first resistor 312A, that first resistor 312A may be cooled by the washing fluid, whereby cooling the first resistor 312A causes a change in resistance thereof. As a result, the voltage across the voltage divider 320 changes accordingly, and this change may be detected by the monitoring device 316. As the washing fluid level continues to rise, and to interact with further resistors in the series, such as a second resistor 312B, those resistors may also be cooled by the washing fluid reaches that corresponding washing fluid level. The resulting change in resistance may thus be detected by the monitoring device 316 via the voltage divider 320.

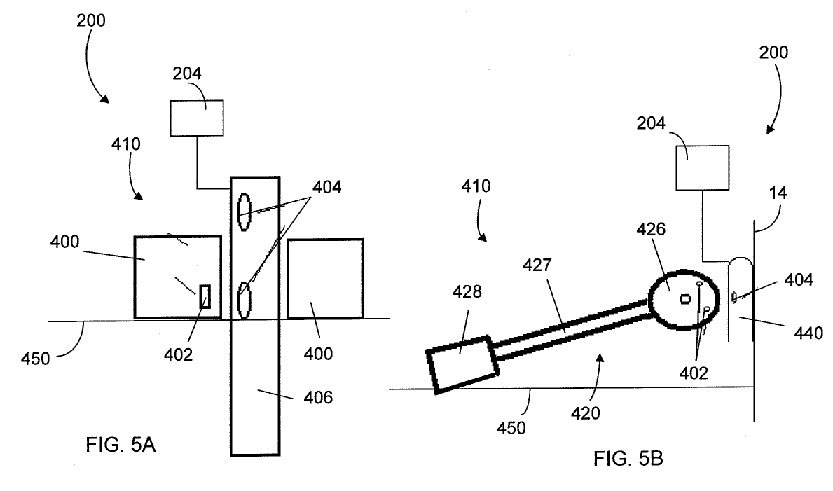

In yet another embodiment, as illustrated in FIGS. 5A and 5B, the fluid level sensing device 202 may comprise a magnetic sensor device 410 configured to detect a change in a magnetic field that may be associated with the washing fluid level and/or a change in the washing fluid level. More particularly, aspects of such a magnetic sensor device 410 may include a plurality of magnetic members 402 disposed in proximity to one or more magnetic sensor elements 404 (implemented in conjunction with a magnetic detector), as schematically illustrated in FIG. 5A. In some instances, one of the plurality of magnetic members 402 and the one or more magnetic sensor elements 404 may be movable in conjunction with the washing fluid level, with respect to the other of the plurality of magnetic members 402 and the one or more magnetic sensor elements 404, so as to be operable at or about the “full” washing fluid level. A change in the magnetic field sensed by the magnetic sensor elements 404 in response to the washing fluid is associated with the detected fluid level or fluid level change and its affect on the magnetic sensor members 404 at a particular time. For example, as shown in FIG. 5A, a buoyant member 400 may be configured to move with the washing fluid level 450 as the washing fluid level rises and falls. At least one magnetic member 402 may be attached to, secured to, or otherwise engaged with the buoyant member 400. At least a pair of spaced-apart magnetic sensor elements 404 (e.g., a Hall effect sensor or a reed switch/sensor) may be operably engaged with a body portion 406 associated, for example, with the sump assembly 14 and/or the tub portion 12. In this manner, the buoyant member 400 may be responsive to the washing fluid associated with the fluid level so as to move the magnetic member(s) 402 past the magnetic sensor elements 404, whereby the change in magnetic field (i.e., due to the disposition or movement of the magnetic members 402) determined by the magnetic detector associated with the magnetic sensor elements 404 may substantially continuously (sometimes in substantially real time) indicate the washing fluid level 450 in the dishwasher 10.

In an alternate embodiment, as shown in FIG. 5B, an arm member 427 may be pivotably engaged with the sump assembly 14 at one end thereof about an engagement area 426, with a float member 428 engaged with the arm member 427 about an opposing end thereof. The arm member 427 may have at least two magnetic members 402 operably engaged therewith, the magnetic members being movable in conjunction with the pivotably engaged arm member and the float member, in response to the washing fluid associated with the fluid level and with respect to the magnetic detector. The float (buoyant) member 428 is thus configured to move in an arcuate motion about the engagement area 426, in conjunction with the washing fluid level 450, as the washing fluid level 450 increases/decreases. In this manner, as the arm member 427 rotates about the engagement area 426, the magnetic members 402 move with respect to the magnetic sensor element(s) 404 attached to, secured to or otherwise engaged with a body portion 440 which may be operably engaged with the sump assembly 14 (or directly engaged with the sump assembly 14). Thus, the change in magnetic field determined by the magnetic detector associated with the magnetic sensor elements 404 may substantially continuously (sometimes in substantially real time) indicate the washing fluid level 450 in the dishwasher 10.

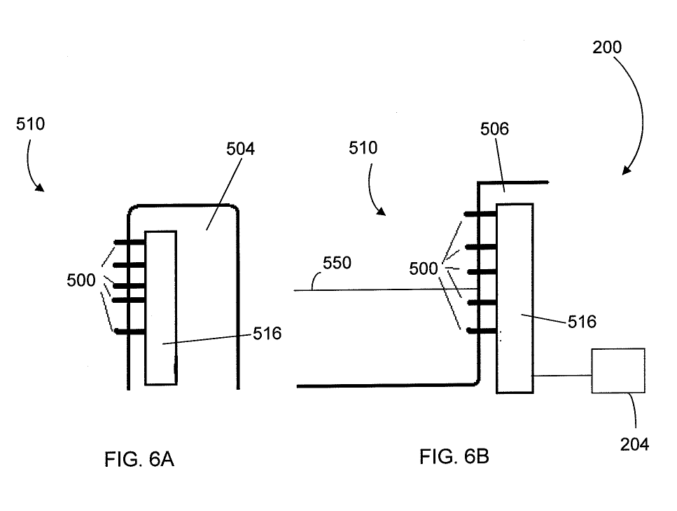

In still another embodiment, as illustrated in FIGS. 6A and 6B, the fluid level sensing device 202 may comprise a conductive sensor device 510 configured to detect a change in conduction (i.e., a completion of a circuit) that may be associated with the washing fluid level and/or a change in the washing fluid level. More particularly, aspects of such a conductive sensor device 510 may include a plurality of spaced-apart (i.e., vertically spaced-apart) conductive members 500 (each comprised of a conductive material) disposed in or about the “full” washing fluid level to interact with the washing fluid, whereby a change in the conduction (i.e., a completed circuit between the conductive members 500 due to the washing fluid interaction therebetween) in response to the washing fluid is associated with the detected fluid level at a particular time. In this regard, the conductive sensor device 510 may be configured to be in communication with a monitoring device 516 (i.e., a conduction detector comprising a microprocessor or processing device implemented in conjunction with a printed circuit board) configured to monitor the circuit completion (change in the conduction) associated with the conductive members 500 in response to the interaction thereof with the washing fluid associated with the washing fluid level 550. In some instances, the conductive members 500 may be received in a mounting body 504 operably engaged with the sump assembly 14, while in other instances the conductive members 500 may be operably engaged with a wall 506 of the sump assembly 14. To maintain or facilitate the fluid-tight integrity of the sump assembly 14, the conductive members 500 may be molded into a polymeric component or potted into a receptacle associated with the sump assembly 14.

Further, in some instances, two or more of the conductive members 500 may be used to measure washing fluid conductivity as indicia of the “hardness” (i.e., mineral content) of the washing fluid, which may correlate with the amount of dishwashing detergent needed for an adequate or otherwise acceptable wash cycle. Additionally, the conductive sensor device 510 may be capable, in some instances, of determining an amount of dishwashing detergent in the washing fluid (water) which, in turn, may be used, for example, to adjust the dishwashing detergent level, to determine when the dishwashing detergent has been substantially rinsed or removed from the dishware, and to verify that a detergent dispenser is working properly.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method of controlling a washing fluid level in a dishwashing appliance, comprising:
filling a sump assembly of a dishwashing appliance with washing fluid to a predetermined fluid level, the predetermined fluid level being determined by a fluid level sensing device directly engaged with the sump assembly, the sump assembly being operably engaged with a tub portion at a lower end thereof;
circulating washing fluid between the sump assembly and the tub portion;
after circulating the washing fluid, determining an operational fluid level within the sump assembly by the fluid level sensing device; and
when the operational fluid level differs from the predetermined fluid level by more than a threshold level, actuating one of a washing fluid drain valve and a washing fluid fill valve to substantially restore the washing fluid to the predetermined fluid level.

2. A method according to claim 1 further comprising generating a signal associated with the determined operational fluid level, with the fluid level sensing device, the signal being directed by the fluid level sensing device to a controller device in communication therewith and capable of directing actuation of the one of the washing fluid drain valve and the washing fluid fill valve in response to the determined operational fluid level.

3. A method according to claim 1 wherein determining an operational fluid level further comprises determining an operational fluid level with the fluid level sensing device comprising an optical sensor device having a light-sensitive detector operably engaged with and capable of sensing light emitted from an associated light source and a change in the sensed light in response to the washing fluid associated with the fluid level.

4. A method according to claim 1 wherein determining an operational fluid level further comprises determining an operational fluid level with the fluid level sensing device comprising a resistive sensor device having a plurality of resistor members configured to interact with the washing fluid and a monitoring device in communication therewith, the monitoring device being configured to monitor at least one of a voltage change and a resistance change associated with the resistor members in response to the washing fluid associated with the fluid level.

5. A method according to claim 1 wherein determining an operational fluid level further comprises determining an operational fluid level with the fluid level sensing device comprising a magnetic sensor device having at least one magnetic member capable of moving with the washing fluid as the fluid level changes, and a magnetic detector configured to detect movement of the at least one magnetic member in response to the washing fluid associated with the fluid level.

6. A method according to claim 1 wherein determining an operational fluid level further comprises determining an operational fluid level with the fluid level sensing device comprising a conductive sensor device having a plurality of conductive contact portions vertically spaced-apart and disposed within the sump assembly so as to be capable of interacting with the washing fluid therein, and a conduction detector in communication therewith and configured to detect completion of a circuit associated with the conductive contact portions in response to the washing fluid associated with the fluid level.

7. A fluid level control device for a dishwashing appliance having a tub portion adapted to contain washing fluid for circulation about dishware received therein, the dishwashing appliance further including a sump assembly disposed at a lower end of the tub portion for receiving the washing fluid therefrom, a washing fluid drain valve for removing washing fluid from the dishwashing appliance, and a washing fluid fill valve for directing washing fluid to the dishwashing appliance, the fluid level control device comprising:
a fluid level sensing device adapted to be directly engaged with the sump assembly of the dishwashing appliance, the fluid level sensing device being configured to determine a washing fluid level, including a predetermined fluid level and an operational fluid level, associated with the washing fluid within the dishwashing appliance, and to generate a first signal and a second signal corresponding to the predetermined fluid level and the operational fluid level, respectively; and
a controller device in communication with the fluid level sensing device and configured to receive the first signal therefrom and respond to the first signal to originate a washing fluid circulation event such that washing fluid is circulated between the sump assembly and the tub portion, the controller device being further configured to receive the second signal after at least a portion of the washing fluid circulation event has elapsed, and respond to the second signal to direct actuation of one of the washing fluid drain valve and the washing fluid fill valve when the operational fluid level differs from the predetermined fluid level by more than a threshold level, to substantially restore the washing fluid to the predetermined fluid level.

8. A device according to claim 7 wherein the fluid level sensing device further comprises an optical sensor device having a light-sensitive detector operably engaged with and capable of sensing light emitted from an associated light source and a change in the sensed light in response to the washing fluid associated with the fluid level.

9. A device according to claim 8 wherein the optical sensor device is configured to be operable with infrared light.

10. A device according to claim 8 further comprising an arm member adapted to be pivotably engaged with the sump assembly at one end, and having a float member engaged therewith about an opposing end, the arm member having a plurality of uniquely-configured reflective portions engaged therewith, the reflective portions being movable in conjunction with the pivotably engaged arm member and the float member, in response to the washing fluid associated with the fluid level and with respect to one of the light source and the light-sensitive detector, such that at least a portion of the light emitted from the light source is reflected from one of the reflective portions and detected by the light-sensitive detector.

11. A device according to claim 7 wherein the fluid level sensing device further comprises a resistive sensor device having a plurality of resistor members configured to interact with the washing fluid and a monitoring device in communication therewith, the monitoring device being configured to monitor at least one of a voltage change and a resistance change associated with the resistor members in response to the washing fluid associated with the fluid level.

12. A device according to claim 7 wherein the fluid level sensing device further comprises a magnetic sensor device having at least one magnetic member capable of moving with the washing fluid as the fluid level changes, and a magnetic detector configured to detect movement of the at least one magnetic member in response to the washing fluid associated with the fluid level.

13. A device according to claim 12 wherein the at least one magnetic member is operably engaged with a float member and is movable with the float member in response to the washing fluid associated with the fluid level, and wherein the magnetic detector comprises at least two vertically spaced-apart reed sensor elements configured to cooperate to sense one of a disposition and a movement of the at least one magnetic member with respect thereto.

14. A device according to claim 12 further comprising an arm member adapted to be pivotably engaged with the sump assembly at one end, and having a float member engaged therewith about an opposing end, the arm member having at least two magnetic members operably engaged therewith, the magnetic members being movable in conjunction with the pivotably engaged arm member and the float member, in response to the washing fluid associated with the fluid level and with respect to the magnetic detector.

15. A device according to claim 7 wherein the fluid level sensing device further comprises a conductive sensor device having a plurality of conductive contact portions vertically spaced-apart and disposed within the sump assembly so as to be capable of interacting with the washing fluid therein, and a conduction detector in communication therewith and configured to detect completion of a circuit associated with the conductive contact portions in response to the washing fluid associated with the fluid level.

16. A device according to claim 15 wherein the conductive contact portions are one of received in a mounting body adapted to operably engage the sump assembly and adapted to operably engage a wall of the sump assembly.

17. A dishwashing appliance comprising:
a tub portion configured to contain washing fluid for circulation about dishware received therein;
a sump assembly disposed at a lower end of the tub portion for receiving the washing fluid therefrom;
a washing fluid drain valve in communication with the sump assembly for removing washing fluid therefrom;
a washing fluid fill valve in communication with the sump assembly for directing washing fluid thereto;
a fluid level sensing device directly engaged with the sump assembly of the dishwashing appliance, the fluid level sensing device being configured to determine a washing fluid level, including a predetermined fluid level and an operational fluid level, associated with the washing fluid within the dishwashing appliance, and to generate a first signal and a second signal corresponding to the predetermined fluid level and the operational fluid level, respectively; and
a controller device in communication with the fluid level sensing device and configured to receive the first signal therefrom and respond to the first signal to originate a washing fluid circulation event such that washing fluid is circulated between the sump assembly and the tub portion, the controller device being further configured to receive the second signal after at least a portion of the washing fluid circulation event has elapsed, and respond to the second signal to direct actuation of one of the washing fluid drain valve and the washing fluid fill valve when the operational fluid level differs from the predetermined fluid level by more than a threshold level, to substantially restore the washing fluid to the predetermined fluid level.

18. An appliance according to claim 17 wherein the fluid level sensing device further comprises an optical sensor device having a light-sensitive detector operably engaged with and capable of sensing light emitted from an associated light source and a change in the sensed light in response to the washing fluid associated with the fluid level.

19. An appliance according to claim 18 wherein the optical sensor device is configured to be operable with infrared light.

20. An appliance according to claim 18 further comprising an arm member pivotably engaged with the sump assembly at one end, and having a float member engaged therewith about an opposing end, the arm member having a plurality of uniquely-configured reflective portions engaged therewith, the reflective portions being movable in conjunction with the pivotably engaged arm member and the float member, in response to the washing fluid associated with the fluid level and with respect to one of the light source and the light-sensitive detector, such that at least a portion of the light emitted from the light source is reflected from one of the reflective portions and detected by the light-sensitive detector.

21. An appliance according to claim 17 wherein the fluid level sensing device further comprises a resistive sensor device having a plurality of resistor members configured to interact with the washing fluid and a monitoring device in communication therewith, the monitoring device being configured to monitor at least one of a voltage change and a resistance change associated with the resistor members in response to the washing fluid associated with the fluid level.

22. An appliance according to claim 17 wherein the fluid level sensing device further comprises a magnetic sensor device having at least one magnetic member capable of moving with the washing fluid as the fluid level changes, and a magnetic detector configured to detect movement of the at least one magnetic member in response to the washing fluid associated with the fluid level.

23. An appliance according to claim 22 wherein the at least one magnetic member is operably engaged with a float member and is movable with the float member in response to the washing fluid associated with the fluid level, and wherein the magnetic detector comprises at least two vertically spaced-apart reed sensor elements configured to cooperate to sense one of a disposition and a movement of the at least one magnetic member with respect thereto.

24. An appliance according to claim 22 further comprising an arm member pivotably engaged with the sump assembly at one end, and having a float member engaged therewith about an opposing end, the arm member having at least two magnetic members operably engaged therewith, the magnetic members being movable in conjunction with the pivotably engaged arm member and the float member, in response to the washing fluid associated with the fluid level and with respect to the magnetic detector.

25. An appliance according to claim 17 wherein the fluid level sensing device further comprises a conductive sensor device having a plurality of conductive contact portions vertically spaced-apart and disposed within the sump assembly so as to be capable of interacting with the washing fluid therein, and a conduction detector in communication therewith and configured to detect completion of a circuit associated with the conductive contact portions in response to the washing fluid associated with the fluid level.

26. An appliance according to claim 25 wherein the conductive contact portions are one of received in a mounting body operably engaged with the sump assembly and operably engaged with a wall of the sump assembly.
